(19) United States
(12) Patent Application Publication
(10) Pub. No.: US 2011/0057964 A1
(43) Pub. Date: Mar. 10, 2011

(54) IMAGE DISPLAY APPARATUS AND METHOD FOR CONTROLLING THE SAME

(75) Inventors: Hidenori Kanazawa, Mishima-shi (JP); Eisaku Tatsumi, Kawasaki-shi (JP); Osamu Sagano, Inagi-shi (JP)

(73) Assignee: CANON KABUSHIKI KAISHA, Tokyo (JP)

(21) Appl. No.: 12/875,225

(22) Filed: Sep. 3, 2010

(30) Foreign Application Priority Data
Sep. 9, 2009 (JP) 2009-208013

(51) Int. Cl. G09G 5/10

(52) U.S. Cl. 345/690

(57) ABSTRACT

An image display apparatus comprises: a display panel; and an image processing unit which divides one frame into a frame of a main image and N frame(s) of sub-image(s), and outputs a video signal that includes the frame of the main image and the frame(s) of the sub-image(s) to the display panel, wherein the image processing unit comprises: a brightness control unit which generates frames corresponding to the main image and the sub-images based on the same input image data, and relatively reduces the brightness of the frame corresponding to the sub-image with respect to the brightness of the frame corresponding to the main image; and a period setting unit which sets a length of respective horizontal scan periods so that the horizontal scan period in the frame of the main image is longer than the horizontal scan period in the frames of the sub-image.

### BACKGROUND OF THE INVENTION

1. Field of the Invention

The present invention relates to an image display apparatus, and a method for controlling the same.

2. Description of the Related Art

As an image display apparatus, an impulse type or a hold type image display apparatus has been used. A characteristic of the impulse type image display apparatus is that the lighting time of display devices is short, and the ON/OFF of the display devices is recognized as flickering. This flickering can be controlled by increasing the frame frequency (increasing a number of images displayed per unit time), for example. But if the same frame is continuously output twice (double writing) in a moving image, the motion is viewed as double, which is recognized as interference.

For the hold type image display apparatus, on the other hand, a method for controlling motion blur is disclosed in Japanese Patent Application Laid-Open Nos. 2004-240317 and 2002-351382.

In concrete terms, Japanese Patent Application Laid-Open No. 2004-240317 discloses that a frame period (a period for displaying one frame) is divided into two periods (first period and second period), and pixel data is intensively written in the first period (the former period in time series). It is also disclosed that the portion exceeding the displayable dynamic range, out of the pixel data to be written in the first period, is written in the second period (the latter period in time series).

Japanese Patent Application Laid-Open No. 2002-351382 discloses that one frame is divided into a frame of a main image that contains unchanged high frequency components and a frame of a sub-image in which high frequency components are changed, so as to increase the frame frequency.

If a conventional technology of the hold type image display apparatus is applied to the impulse type image display apparatus, the length of the frame period after division is limited, and therefore the brightness of the display image may drop. In concrete terms, if two frames are generated out of one frame, the frame period becomes half of the original frame period. And if the brightness is changed between the main image and the sub-image, in some cases the brightness may become lower than the original image. In the method disclosed in Japanese patent Application Laid-Open No. 2004-240317, the portion exceeding the displayable dynamic range, out of the pixel data to be written in the first period, is written in the second period, so the pixel data having high brightness value is written twice, which may cause interference in the moving image.

### SUMMARY OF THE INVENTION

The present invention provides a technology that can control the generation of interference in the moving image and drop in brightness of the image.

An image display apparatus according to the present invention, comprises:

a display panel driven by multiplex scanning; and

an image processing unit which divides one frame having a predetermined period into a frame of a main image and N (N is a positive integer) frame(s) of sub-image(s), and outputs a video signal that includes the frame of the main image and the frame(s) of the sub-image(s) to the display panel based on input image data, wherein

the image processing unit comprises:

a brightness control unit which generates frames corresponding to the main image and the sub-image based on the same input image data, and relatively reduces the brightness of the frame corresponding to the sub-image with respect to the brightness of the frame corresponding to the main image; and

a period setting unit which sets a length of respective horizontal scan periods so that the horizontal scan period in the frame of the main image is longer than the horizontal scan period in the frame of the sub-image.

A method for controlling an image display apparatus having a display panel driven by multiplex scanning, according to the present invention, comprises the steps of:

dividing one frame having a predetermined period into a frame of a main image and N (N is a positive integer) frame(s) of sub-image(s), and outputting a video signal that includes the frame of the main image and the frame(s) of the sub-image(s) to the display panel based on input image data; and

setting a length of respective horizontal scan periods so that the horizontal scan period in the frame of the main image is longer than the horizontal scan period in the frame of the sub-image, wherein

the main image and the sub-image are images generated from the same input image data, and the sub-image is an image of which brightness is relatively reduced with respect to the brightness of the main image.

According to the present invention, a technology that can control the generation of interference in the moving image and drop in brightness of the image can be provided.

Further features of the present invention will become apparent from the following description of exemplary embodiments with reference to the attached drawings.

### BRIEF DESCRIPTION OF THE DRAWINGS

FIG. 1A and FIG. 1B are diagrams depicting an example of drive waveforms by pulse width limiting;

FIG. 1C and FIG. 1D are diagrams depicting an example of drive waveforms by time sharing;

FIG. 2 is a diagram depicting an example of a configuration of a brightness sharing block;

FIG. 3 is a diagram depicting an example of the input/output relationship of each signal of the brightness distribution block;

FIG. 4 is a diagram depicting an example of a configuration of a time sharing block;

FIG. 5 is a diagram depicting an example of the input/output relationship of each signal of a frame length setting circuit;

FIG. 6 is a diagram depicting an example of the input/output relationship of each signal of the time distribution block;

FIG. 7 is a diagram depicting an example of a configuration of an image display apparatus according to the present embodiment;

FIG. 8 is a diagram depicting an example of the input/output relationship of each signal of the brightness sharing block;

FIG. 9A is a diagram depicting an example of the drive waveform of the input image data;

FIG. 9B and FIG. 9C are diagrams depicting an example of drive waveforms by the brightness sharing; and

FIG. 10 is a diagram depicting an example of a circuit configuration for limiting a pulse width

### DESCRIPTION OF THE EMBODIMENTS

An image display apparatus and a method for controlling the image display apparatus according to an embodiment of the present invention will now be described. The image display apparatus according to this embodiment has a display panel driven by multiplex scanning and an image processing circuit (image processing unit). The image processing circuit divides one frame having a predetermined period into a frame of a main image and N (N is a positive integer) frame(s) of sub-image(s), and outputs a video signal that includes the frame of the main image and the frame(s) of the sub-image(s) to the display panel. The main image and the sub-image are images that have a same content and different brightness. Here “the main image and the sub-image have a same content” means there is no movement or no substantial movement between the main image and the sub-image. In concrete terms, the main image and the sub-image are images generated from a same image, and the only differences are the brightness and frequency component.

The present invention can be applied to the impulse type image display apparatus and the hold type image display apparatus, but can preferably be applied to the impulse type image display apparatus since a drop in brightness can be controlled.

In this example, it is assumed that the video signal that is input is not a video signal including a frame of a main image and N frame(s) of sub-image(s). And it is assumed that the image processing circuit has a function to generate frames corresponding to the main image and the sub-image respectively based on the same input image data, and to reduce the brightness of the frame corresponding to the sub-image to be relatively lower than the brightness of the frame corresponding to the main image. The main image and the sub-image to be generated are images obtained by reducing the brightness of the frame corresponding to each image at a mutually different reduction rate based on the input image data. A drive method for dividing (distributing) an image of one frame into a plurality of images having different brightness is called “brightness sharing”.

### Example 1

### General Configuration

Now an image display device which drives at double speed (in the case of N=1) will be described as Example 1 of the present invention.

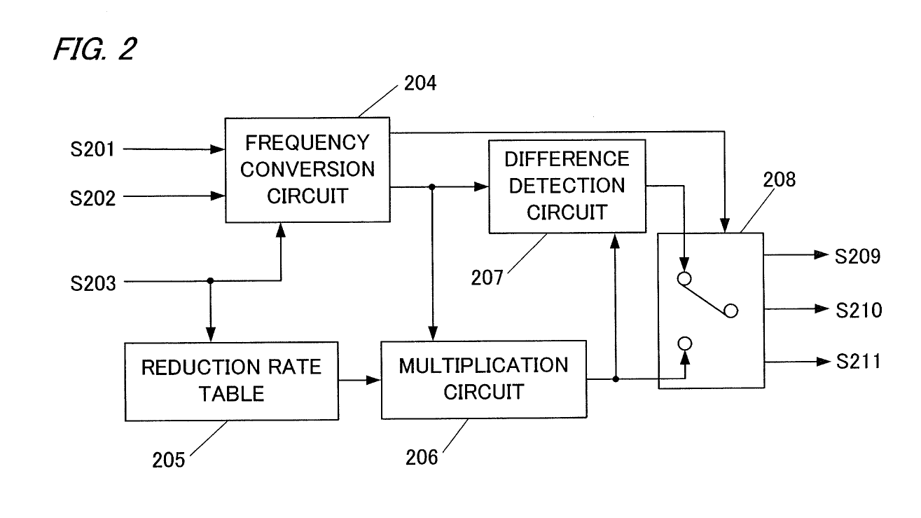

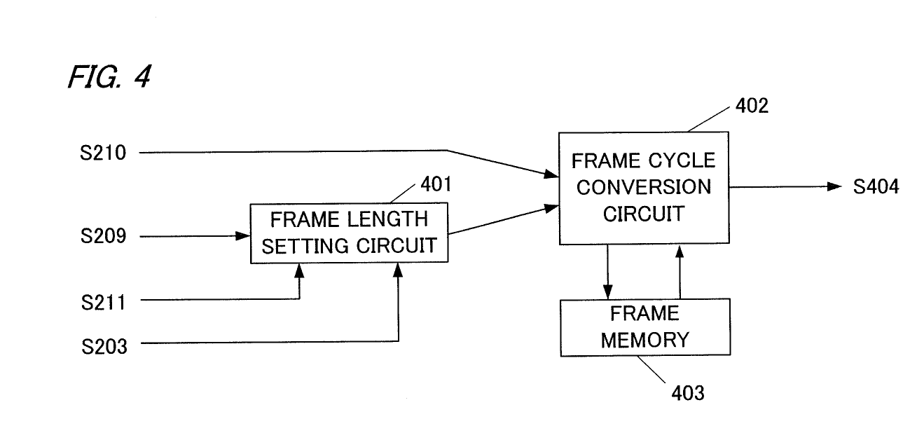

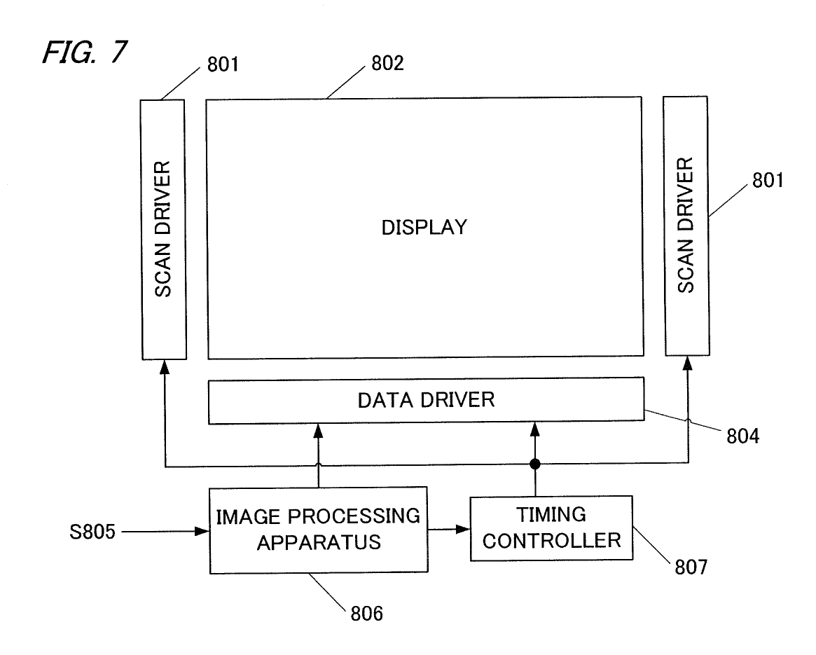

FIG. 7 is a diagram depicting an example of the configuration of the image display apparatus according to this example. In the case of the image display apparatus in FIG. 7, a plurality of display devices are driven in a multiplex scanning by a scan driver 801 (scan circuit) and data driver 804 (modulation circuit). An image processing apparatus (image processing circuit) 806 comprised of a brightness sharing block in FIG. 2 and a time sharing block in FIG. 4 generates and outputs the output image data and synchronization signals thereof based on the input image data 5805 and synchronization signals thereof. The synchronization signal includes a vertical synchronization signal (Vsync) which indicates the start and end (frame period) of one frame, and a horizontal synchronization signal (Hsync) which indicates the start and end of one horizontal scan period. The input image data is one frame of image data (frame data) of the video signal which was input, and the output image data is one frame of image data of the video signal to be output. The synchronization signal of the output image data is output to the timing controller 807. The timing controller 807 controls the output timing of the output image data from the scan driver 801 and data driver 804 to each device. The output image data is output to the data driver 804 synchronizing with the synchronization signal. The scan driver 801 outputs the scan signal synchronizing with the synchronization signal. The data driver 804 outputs a modulation signal according to the output image data. By the above mentioned operation, the image is displayed on the display 802. In the example in FIG. 7, the display panel is constituted by the scan driver 801, display 802, data driver 804 and timing controller 807. The display device is, for example, an electron emitting device, a liquid crystal device, a plasma device and an organic EL device.

Now a method for controlling gradation in the impulse type image display apparatus will be described. In the impulse type image display apparatus, the gradation can be controlled by changing the pulse amplitude and/or the pulse width of the modulation signal.

In the pulse width modulation method, brightness can be increased by increasing the pulse width as the gradation value becomes higher. In this case, if the frame frequency is increased by brightness sharing, the horizontal scan period (maximum pulse with) per frame decreases, and therefore in some cases the pulse width corresponding to the gradation value of the image generated based on the brightness sharing (distributed image (main image, sub-image)) may exceed the maximum pulse width. A possible method for solving this problem is a method for limiting the pulse width so as to not exceed the maximum pulse width. This will be described in detail.

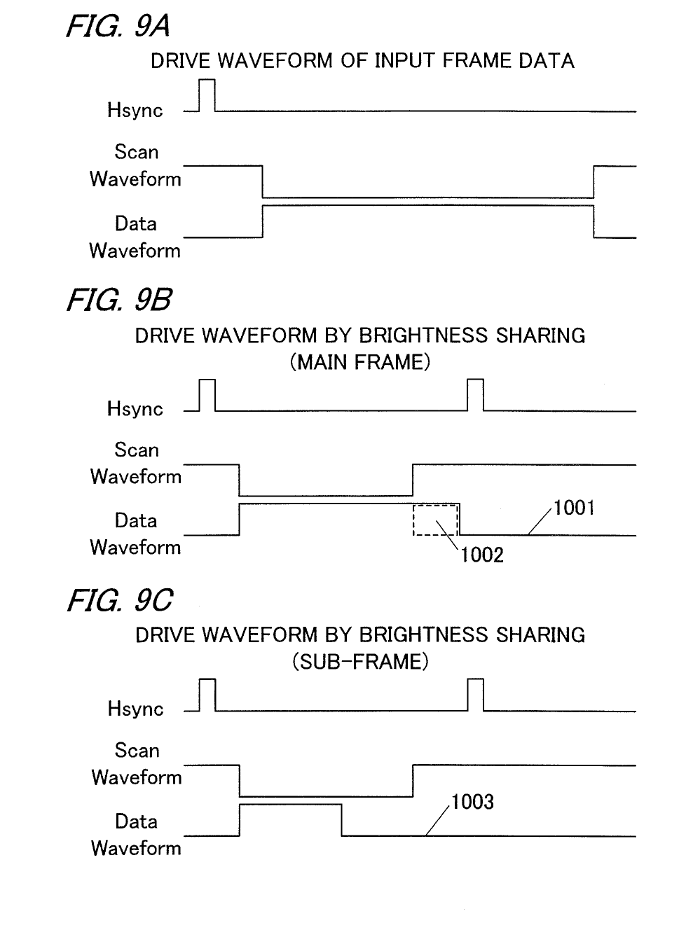

FIG. 9A shows an example of the drive waveform (waveform of modulation signal) of the input image data S202 to be input to the brightness sharing block in FIG. 2. FIG. 9B and FIG. 9C show examples of the drive waveforms of the frame data of the main image and the frame data of the sub-image which are generated by the brightness sharing based on the input image data. In FIG. 9A to FIG. 9C, “scan waveform” indicates the waveform of the scan signal. The brightness sharing block in FIG. 2 will be described in detail later.

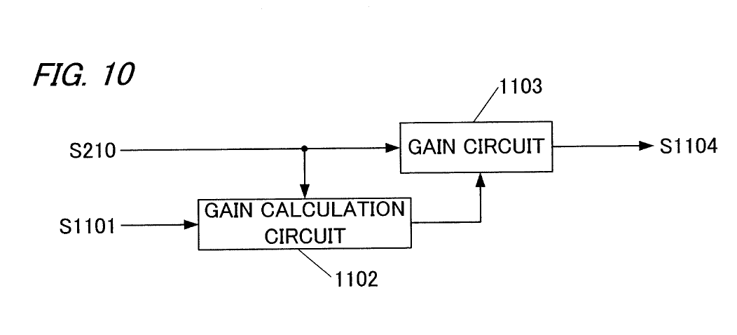

If the ratio of the brightness sharing (ratio of the brightness of the main image with respect to the brightness of the sub-image) is set high, the pulse width of the drive waveform 1001, for displaying the main image, exceeds the horizontal scan period, as shown by the reference numeral 1002 in FIG. 9B. Therefore the pulse width is decreased using the circuit shown in FIG. 10.

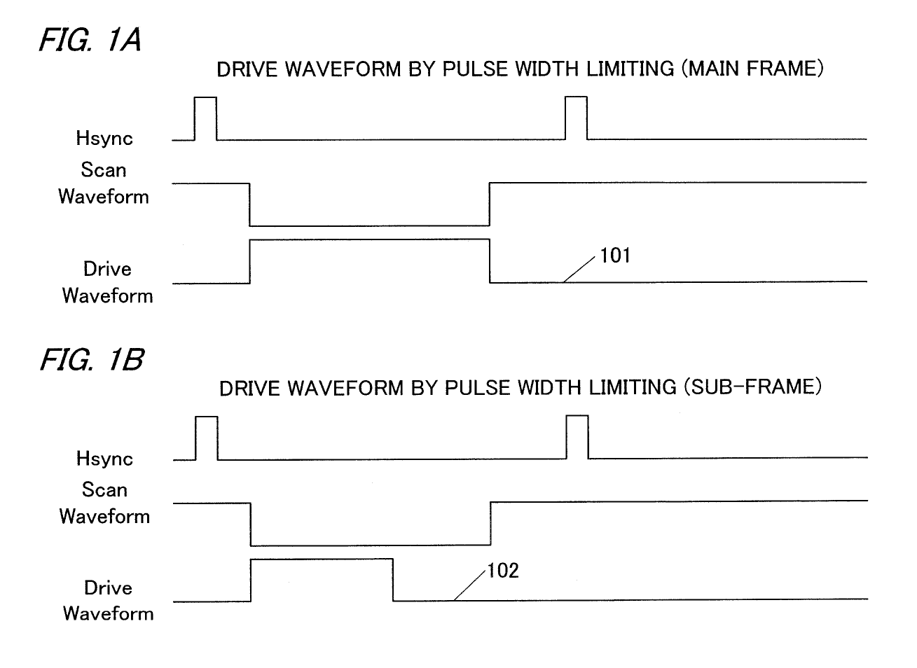

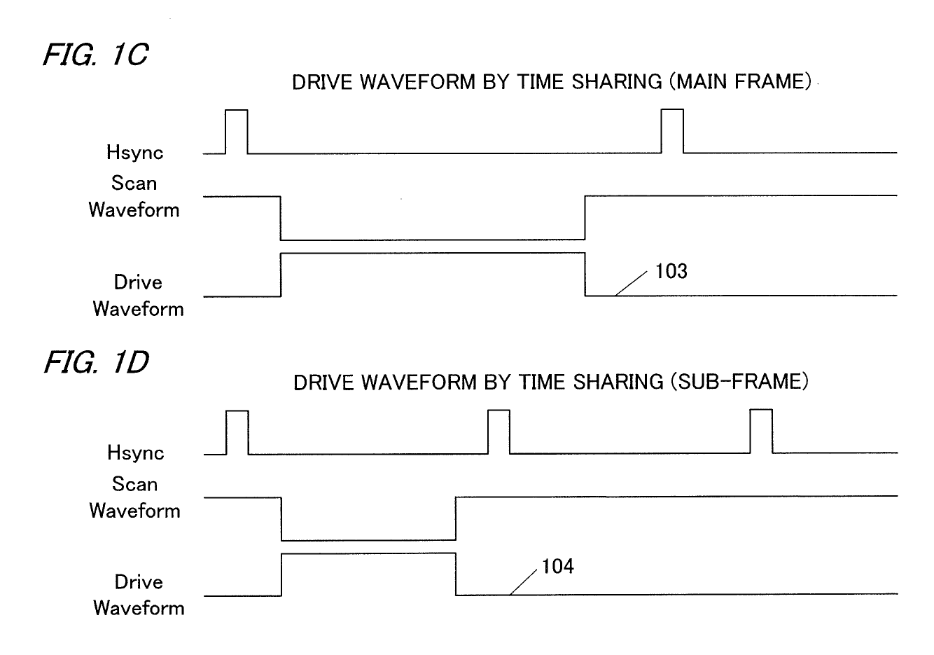

The frame data S210 of the distributed image (main image, sub-image) generated in the brightness sharing block in FIG. 2 is input to the gain circuit 1103. The limiting value S1101 in FIG. 10 is a maximum pulse width which is determined depending on the horizontal scan period. If the pulse width of the drive waveform for displaying the main image exceeds the limiting value S1101, the gain calculation circuit 1102 calculates the gain value for the pulse width that does not exceed the limiting value S1101, and outputs it to the gain circuit 1103. The gain circuit 1103 multiplies frame data S210 by the gain value calculated in the gain calculation circuit 1102, and outputs the output image data S1104. As a result, the drive waveform for displaying the main image changes from the drive waveform 1001 in FIG. 9B to the drive waveform 101 in FIG. 1A (the pulse width becomes the maximum pulse width or less). The drive waveform for displaying the sub-image changes from the drive waveform 1003 in FIG. 9C to the drive waveform 102 in FIG. 1B (the pulse width of the drive waveform 1003 is also limited as the pulse width of the drive waveform 1001 is limited). Thereby the ratio of the brightness sharing is maintained. By this method, the frame frequency can be increased without generating interference in the moving image. A problem of this method, however, is that the image to be displayed becomes darker than the original image (image displayed based on the input image data) since the pulse width is decreased using the gain value.

In order to perform brightness sharing in the impulse type image display apparatus, which modulates the pulse width, with controlling interference and drop in brightness in the moving image, the main image must be displayed brighter than the prescribed value. The absolute rating of a modulation signal is determined by characteristics unique to the display, so the only way to implement high brightness is to increase the pulse width. Therefore in this example, the length of the respective horizontal scan periods is set by the time sharing block shown in FIG. 4 so that the horizontal scan period in the frame of the main image becomes longer than the horizontal scan period in the frame of the sub-image.

Thereby the pulse width of the drive waveform can be increased as shown in the drive waveform 103 in FIG. 1C. The total length of the horizontal scan period in the frame of the main image and the horizontal scan period in the frame of the sub-image must be the same as the length of the horizontal scan period in one frame of the video signal which was input. This means that the horizontal scan period in the frame of the sub-image must be decreased for the amount of increase of the length of the horizontal scan period in the frame of the main image. Hence the maximum pulse width of the drive waveform for displaying the sub-image decreases, and the brightness of the sub-image is limited. However the sub-image is originally a dark image, and if the horizontal scan period in the frame of the main image is set to the maximum gradation that is required, the pulse width of the drive waveform for displaying the sub-image does not exceed the horizontal scan period, as shown in the drive waveform 104 in FIG. 1D. This will be described in detail herein below.

### (Brightness Sharing)

In this example, a frame of one main image and a frame of one sub-image are generated from one frame of a video signal, which was input, by the brightness sharing block in FIG. 2. For example, the respective reduction rate is determined for the main image and the sub-image(s) based on the number of frame(s) of the sub-image(s). In concrete terms, the respective reduction rate is determined for the main image and the sub-image based on the number of frames (dividing number S203) generated from one frame of the video signal which was input (in this example, the dividing number S203 is 2). Then the frame of the main image and the frame of the sub-image are generated with the respective reduction rate which was determined.

First the input image data S202 and a synchronization signal S201 thereof are input to the frequency conversion circuit 204. The dividing number S203 is input to a frequency conversion circuit 204 and the reduction rate table 205 (the dividing number S203 may be set by the user or may be predetermined). Then the frequency conversion circuit 204 converts the frame frequency according to the dividing number S203. In this example, the frame frequency is converted into double that which was input (multiplied by the dividing number). The reduction rate table 205 is a table in which a total number of frames in a frame group constituted by a frame of a main image and N frame(s) of sub-image(s) (that is a dividing number) is related with the ratio of the brightness between the main image and the sub-image(s). In concrete terms, the reduction rate table 205 is a table in which the dividing number is related with the reduction rate of the sub-image (as a result, the dividing number is related with the ratio of the brightness between the main image and the sub-image).

Then the frequency conversion circuit 204 outputs the synchronization signal S209 after the frequency conversion processing is performed (signal of which frame period and horizontal scan period are half of those which were input) to a switch circuit 208, and outputs the input image data S202 to a difference detection circuit 207 and a multiplication circuit 206. The reduction rate table 205 outputs the reduction rate related to the dividing number S203 (=2) to the multiplication circuit 206.

The multiplication circuit 206 generates frame data of the sub-image by reducing the brightness of the input image data S202 at the reduction rate which was input (multiplying each pixel value of the input image data S202 by the reduction rate which was input). The frame data of the sub-image is output to the difference detection circuit 207 and the switch circuit 208.

The difference detection circuit 207 generates the frame data of the main image by subtracting the frame data of the sub-image from the input image data S202. The frame data of the main image is output to the switch circuit 208.

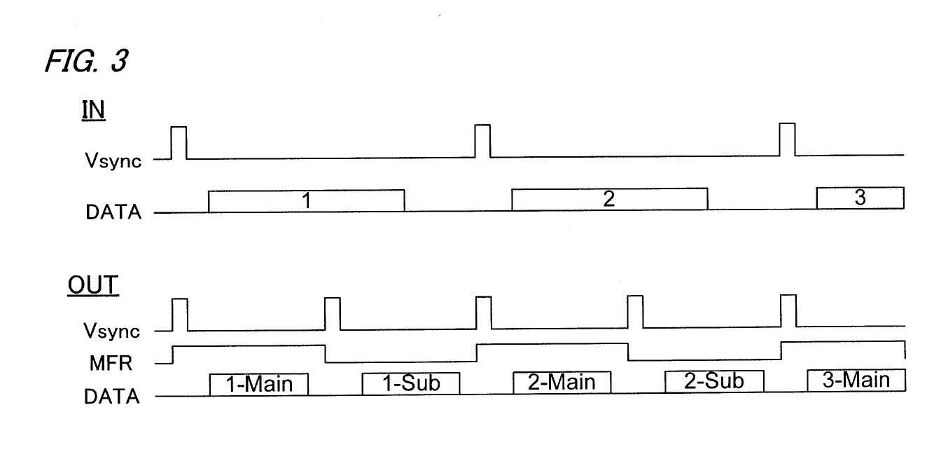

The switch circuit 208 switches the frame data and outputs it according to the synchronization signal S209. The switch circuit 208 outputs the synchronization signal S209. The switch circuit 208 also outputs the main/sub-identification signal S211 for easily determining whether the frame data, which was output, is the frame data of the main image frame data or the frame data of the sub-image frame data. A main/sub-identification signal S211 is a signal which becomes H at the same time with the rise of Vsync to indicate the start of the main image, and becomes L at the same time with the rise of Vsync to indicate the start of the sub-image. FIG. 3 shows the input/output relationship of each signal in FIG. 2 (Hsync is omitted). In FIG. 3, the image data (frame data) is denoted by DATA, and the main/sub-identification signal is denoted by MFR. It does not matter whether the main image or the sub-image is output first.

In the present example, it is assumed that the reduction rate is stored in the reduction rate table 205 in advance, but the reduction rate and the ratio of brightness between the main image and sub-image may be input from the outside (may be set by the user). These values may also be calculated based on the characteristics of the input image data S202.

In this example, the frame data of the main image frame data is calculated (generated) by subtracting the frame data of the sub-image from the input image data S202, but the method for generating the main image frame data is not limited to this. Only if the reduction rate of the main image can be set (obtained), then the frame data of the main image can be generated by multiplying the input image data S202 by this reduction rate. In this case however, the respective reduction rate must be set so that the total of the horizontal scan period in each distributed image frame does not exceed the horizontal scan period in the frame of the input image data S202.

In this example, the table in which the dividing number is related with the reduction rate of the sub-image is the reduction rate table 205, but the reduction rate table 205 may be a table in which the dividing number is related with the reduction rate of the main image. The reduction rate table 205 may also be a table in which the dividing number is related with the reduction rates of the main image and sub-image, or a table in which the dividing number is related with the ratio of brightness between the main image and sub-image.

### (Time Sharing)

A method for appropriately setting the horizontal scan period of the brightness-distributed frame data will now be described. FIG. 4 shows an example of a time sharing block.

Frame data S210 of the distributed image generated in the brightness sharing block is input to a frame cycle conversion circuit 402.

The synchronization signal S209 and main/sub-identification signal S211, which were generated in the brightness sharing block, and the dividing number S203, which was input in the brightness sharing block in FIG. 2, are input to the frame length setting circuit 401.

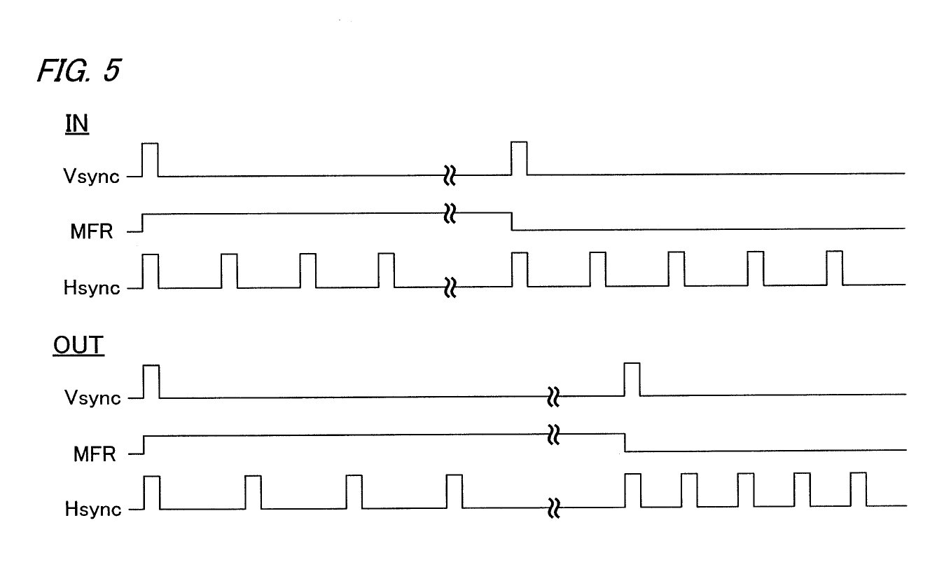

The frame length setting circuit 401 sets the length of the respective horizontal scan periods so as to correspond to the ratio of brightness between the main image and sub-image (changes the space of synchronization signals). In concrete terms, the maximum pulse width and horizontal scan period, required for displaying the main image and sub-image, are determined depending on the brightness of the main image and sub-image respectively. In this example, the frame length setting circuit 401 sets the length of the horizontal scan period for the frame of the main image and frame of the sub-image respectively, by referring to the reduction rate table 205. Since the dividing number is related with the ratio of the brightness between the main image and sub-image in advance, the frame length setting circuit 401 sets the respective length of the horizontal scan period so as to correspond to the ratio of brightness related with the dividing number S203. The frame length setting circuit 401 determines whether the frame data which was input is the main image frame data or the sub-image frame data, by the main/sub-identification signal S211. The changed synchronization signal is output to the frame cycle conversion circuit 402. FIG. 5 shows the input/output relationship of each signal in the frame length setting circuit 401.

The frame cycle conversion circuit 402 outputs the frame data of the distributed image, generated in the brightness sharing block, synchronizing with the synchronization signals changed by the frame length setting circuit 401. The frame cycle conversion circuit 402 also outputs the synchronization signal changed by the frame length setting circuit 401. In the brightness sharing block, the frame period is divided into two, and output, so data contention may be generated in the blanking period between frames or during the main image frame period, depending on the horizontal scan period that is set by the frame length setting circuit 401. To prevent this, all of the frame data of the distributed images, generated based on one frame of the video signal which was input, is stored once in the frame memory 403. Then the frame cycle conversion circuit 402 reads the frame data of the distributed image from the frame memory 403, and outputs it.

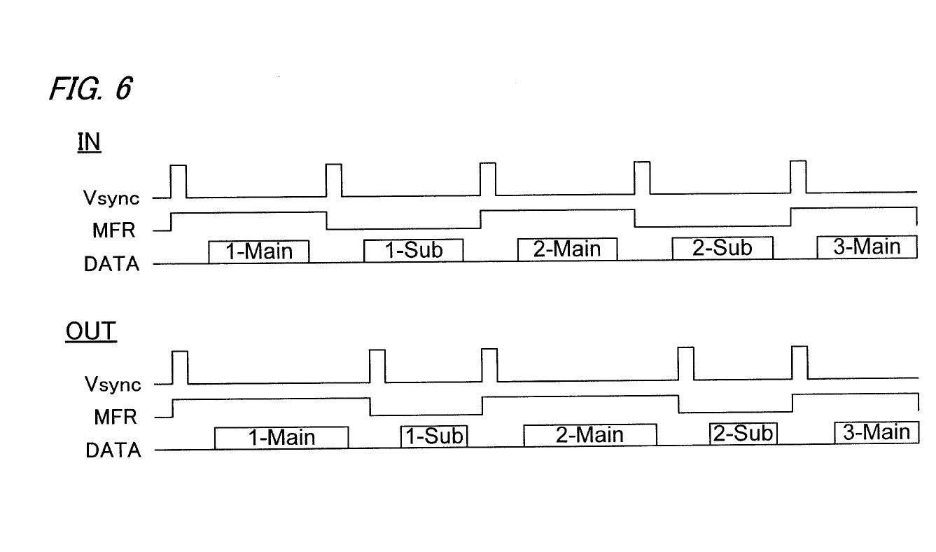

FIG. 6 shows the input/output relationship of each signal in the time sharing block (Hsync is omitted). As FIG. 5 and FIG. 6 show, according to this example, the respective length of the horizontal scan period (space between rises of Hsync and vertical synchronization Vsync) is set corresponding to the ratio of brightness between the main image and sub-image. In concrete terms, the horizontal scan period in the frame of the main image is set longer than the horizontal scan period in the frame of the sub-image, since the main image is brighter than the sub-image. As a result, the main image can be displayed without dropping the brightness (in a state as generated in the brightness sharing block). Since the ratio of the brightness between the main image and sub-image is maintained, the generation of interference of the moving image can be controlled.

The present inventors confirmed by experiments that interference of the moving image can be decreased if the ratio of the brightness of the main image, with respect to the brightness of the sub-image, is 1.2 or more. Hence it is preferable that the length of the horizontal scan period in the frame of the main image is 1.2 times or more than the length of the horizontal scan period in the frame of the sub-image. Then the interference of the moving image can be further decreased by the brightness sharing. In theory, it is sufficient if the length of the horizontal scan period in the frame of the main image is 1.2 times or more than the length of the horizontal scan period in the frame of the sub-image, and no special upper limit is required. However in practical terms, the horizontal scan period in the frame of the main image is set to be shorter than five times the horizontal scan period in the frame of the sub-image.

In this example, the length of the respective horizontal scan periods is set so as to correspond to the ratio of brightness between the main image and sub-image, but the method for setting the horizontal scan period is not limited to this. Any setting method can be used only if the horizontal scan period in the frame of the main image is set to be longer than the horizontal scan period in the frame of the sub-image. If the horizontal scan period in the frame of the main image is longer than the horizontal scan period in the frame of the sub-image, the main image can be brighter compared with the case of the horizontal scan period in the frame of the main image and the horizontal scan period in the frame of the sub-image that have the same length.

In this example, the frame data is output according to the Vsync and Hsync, but the output of the frame data may be controlled by DE (Display Enable).

This example describes the case when the modulation method is the pulse width modulation method, but the modulation method may also be the pulse amplitude modulation method or may be a method for modulating both the pulse width and the pulse amplitude. In concrete terms, in the case of the pulse amplitude modulation method, the gradation value can be increased by increasing the pulse amplitude, but the maximum value of the pulse amplitude is limited by the absolute rating. According to the configuration of this example, even if the pulse amplitude modulation method or a method for modulating both the pulse width and pulse amplitude, is used, the brightness to be obtained can be increased by increasing the pulse width using the time sharing, hence the above mentioned effect can be implemented.

In this example, a case when only brightness is different, between the main image and sub-image, was described, but the frequency component may be changed between the main image and sub-image, using a low pass filter (LPF) or a high pass filter (HPF). For example, interference of a double image can be further decreased by decreasing the high frequency component of the sub-image.

### Example 2

In Example 1, an image display apparatus, which drives at double speed (in the case of N=1), was described. In this example, a case of generating the frame data of a plurality of sub-images is described. In concrete terms, a case of N=3 is described as an example. Description of functions and a configuration the same as Example 1 are omitted.

### (Brightness Sharing)

First in the brightness sharing block in FIG. 2, a frame of one main image and three frames of sub-images are generated based on the input image data S202. A major processing flow is the same as Example 1, but in this example, 4 is input as the dividing number S203. The reduction rate table 205 outputs the total of the reduction rate of the sub-images in the case of outputting the frame data of the main image (in the case when the switch circuit 208 selects to output the frame data of the main image synchronizing with the synchronization signal S209). In concrete terms, the reduction rate table 205 outputs a value of the reduction rate related with the dividing number S203 (=4) multiplied by a value of the dividing number S203 from which 1 is subtracted (that is N). The multiplication circuit 206 multiplies the input image data S202 by this value, and the difference detection circuit 207 subtracts the output of the multiplication circuit 206 from the input image data S202, whereby the frame data of the main image is generated. In the case of outputting the frame data of the sub-image, on the other hand, the reduction rate table 205 outputs the reduction rate related with the dividing number S203, just like Example 1. Then the multiplication circuit 206 multiplies the input image data S202 by this reduction rate, whereby the frame data of the sub-image is generated.

The switch circuit 208 selects to output the frame data of the main image first, then selects to output the frame data of the sub-image continuously for three times (the sequence is not limited to this, only if the frame data of all the distributed images generated based on the input image data S202 are output).

The main/sub-identification signal S211 becomes H at the same time with the rise of the Vsync to indicate the start of the main image, and becomes L at the same time with the rise thereof to indicate the start of the sub-image. In other words, the main/sub-identification signal S211 becomes L in the frame period of the three sub-images.

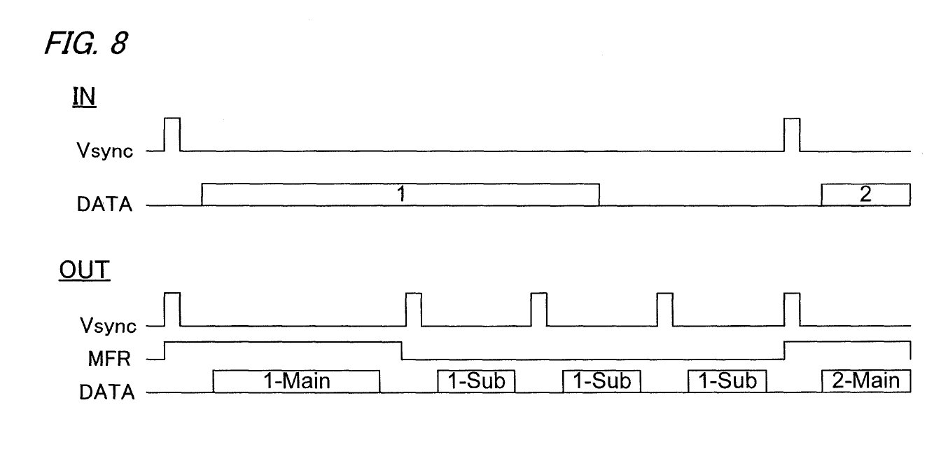

FIG. 8 shows the input/output relationship of each signal in FIG. 2 (Hsync is omitted).

The reduction rate of the main image may be set (obtained) so that the frame data of the main image is directly generated based on the input image data S202 using this reduction rate. The reduction rates of the three sub-images may be different from one another.

### (Time Sharing)

The configuration of the time sharing block is the same as Example 1. Each signal generated in the brightness sharing block and dividing number S203 are input into the time sharing block, and the horizontal scan period in the frame of each distributed image is set (synchronization signal is changed), just like Example 1, and the frame data of each distributed image and changed synchronization signals are output.

According to the configuration of this example, the generation of interference of the moving image and drop in brightness of the image can be controlled, regardless the dividing number.

According to the image display apparatus and the method for controlling the image display apparatus of the present embodiment, the respective horizontal scan periods are set so that the horizontal scan period in the frame of the main image is longer than the horizontal scan period in the frame of the sub-image. Since this allows displaying a bright image as the main image, the generation of interference in the moving image and drop in brightness of the image can be controlled.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-208013, filed on Sep. 9, 2009, which is hereby incorporated by reference herein in its entirety.

What is claimed is:

1. An image display apparatus, comprising:
a display panel driven by multiplex scanning; and
an image processing unit which divides one frame having a predetermined period into a frame of a main image and N (N is a positive integer) frame(s) of sub-image(s), and outputs a video signal that includes the frame of the main image and the frame(s) of the sub-image(s) to the display panel based on input image data, wherein
the image processing unit comprises:
a brightness control unit which generates frames corresponding to the main image and the sub-image based on the same input image data, and relatively reduces the brightness of the frame corresponding to the sub-image with respect to the brightness of the frame corresponding to the main image; and
a period setting unit which sets a length of respective horizontal scan periods so that the horizontal scan period in the frame of the main image is longer than the horizontal scan period in the frame of the sub-image.

2. The image display apparatus according to claim 1, wherein
the main image and the sub-image are images obtained by reducing the brightnesses of the frames corresponding to the respective images at different reduction rates based on the input image data.

3. The image display apparatus according to claim 2, wherein
the brightness control unit determines the respective reduction rates for the main image and sub-image(s) based on the number of frame(s) of the sub-image(s).

4. The image display apparatus according to claim 1, wherein
the period setting unit sets the length of the respective horizontal scan periods so as to correspond to the ratio of brightness between the main image and sub-image.

5. The image display apparatus according to claim 4, further comprising a table in which a total number of frames in a frame group constituted by the frame of the main image and the N frame(s) of the sub-image(s) is related with the ratio of brightness between the main image and sub-image(s) and wherein
the period setting unit sets the length of the respective horizontal scan periods for the frame of the main image and the frame of the sub-image with reference to the table.

6. The image display apparatus according to claim 1, wherein
the length of the horizontal scan period in the frame of the main image is 1.2 times or more than the length of the horizontal scan period in the frame of the sub-image.

7. The image display apparatus according to claim 1, wherein
a gradation of an image is controlled by changing the pulse width of a modulation signal output from a data driver based on the video signal.

8. A method for controlling an image display apparatus having a display panel driven by multiplex scanning, comprising the steps of:
dividing one frame having a predetermined period into a frame of a main image and N (N is a positive integer) frame(s) of sub-image(s), and outputting a video signal that includes the frame of the main image and the frame(s) of the sub-image(s) to the display panel based on input image data; and
setting a length of respective horizontal scan periods so that the horizontal scan period in the frame of the main image is longer than the horizontal scan period in the frame of the sub-image, wherein
the main image and the sub-image are images generated from the same input image data, and the sub-image is an image of which brightness is relatively reduced with respect to the brightness of the main image.
